(19) United States
(12) Patent Application Publication
(10) Pub. No.: US 2005/0161528 A1
(43) Pub. Date: Jul. 28, 2005

(54) Two step cleaning-treatment process and packaging

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/765,495

(22) Filed: Jan. 26, 2004

(51) Int. Cl. B05D 1/00; B05B 17/00; A62C 13/62; A62C 35/58

(52) U.S. Cl. 239/302; 239/1; 239/303

(57) ABSTRACT

A two step cleaning-treatment process and packaging that is portable and can be used anytime and anyplace and applied with great accuracy to desired location. In the preferred embodiment, the two step cleaning-treatment packaging comprises of a small portable packaging with one or more swab applicators for cleaning and one or more swab applicators for treatment. In the most preferred embodiment, the cleaning solution is sealed within the swab applicator and may be easily released into the applicator tip for application, and the treatment medication is sealed within another swab applicator and may be easily released into the applicator tip for application.

### BACKGROUND

1. Field of Invention

The present invention relates generally to a two step cleaning-treatment process and packaging. More specifically, the present invention relates to a two step cleaning-treatment process that is contained in an integrated package.

2. Description of Related Art

Human skin, particularly the facial skin, requires periodic cleaning. This cleaning is generally performed with water and a cleaning agent such as soap. When there is a skin problem or infection, such as acne and athlete's foot, a treatment is generally required after the cleaning. Acne is the term for plugged pores (blackheads and whiteheads), pimples, and even deeper lumps (cysts or nodules) that occur on the face, neck, chest, back, shoulders, and even the upper arms. Acne affects most teenagers to some extent. However, the disease is not restricted to any age group; adults in their 20s—even into their 40s—can get acne. While not a life threatening condition, acne can be upsetting and disfiguring. When severe, acne can lead to serious and permanent scarring. Even less severe cases can lead to scarring. Athlete's foot, or tinea pedis, is a fungal infection, tiny plant-like “germs,” that can grow and multiply on human skin, especially the feet.

Conventional teachings for the treatment of acne and athlete's foot comprises of a regiment of daily cleaning with soap and water follow by application of medication to treat the problem areas. This regiment is generally performed at home where a sink and a supply of water is available. Generally, the entire area, including the affected area, is cleaned with soap and water. For example, for acne on the face, the entire facial area is rinsed and washed with soap and water, and for athlete's foot, the entire foot is rinsed and washed with soap and water. After the cleaning, a medication is applied with a cotton swab or a patch to the problem areas to minimize or cure the skin condition. Generally, the medication is applied only to the problem areas, such as the acne or the location of the fungal infection for athlete's foot. The medication is generally not applied to the entire area, such as the entire face or the entire foot.

This regiment cannot be conveniently performed away from a sink or a clean source of water, such as outside of the home or restroom. Furthermore, this regiment may result in unnecessary and excess cleaning of the skin which may cause irritation and drying of the healthy skin around the affected area. Only the affected area needs the cleaning and treatment, however, with the conventional method, the entire surrounding area must be cleaned. This inconvenience and the unnecessary excess cleaning is avoided with the present invention.

### BRIEF SUMMARY OF THE INVENTION

The present invention is a two step cleaning-treatment process and packaging that is portable and can be used anytime and anyplace and applied with great accuracy to desired location. In the preferred embodiment, the two step cleaning-treatment packaging comprises of a small portable packaging with one or more swab applicators for cleaning and one or more swab applicators for treatment. In the most preferred embodiment, the cleaning solution is sealed within the swab applicator and may be easily released into the applicator tip for application, and the treatment medication is sealed within another swab applicator and may be easily released into the applicator tip for application. The most preferred swab applicator is the slender tubular container disclosed in U.S. Pat. No. 5,702,035. The most preferred cleaning solution is a non-toxic environmentally friendly aqueous disinfectant disclosed in U.S. Pat. No. 6,197,814 B1.

### BRIEF DESCRIPTION OF THE DRAWINGS

FIG. 1 shows the two step cleaning-treatment process and packaging in an aluminum foil package.

FIG. 2 shows the two step cleaning-treatment process and packaging in a small hardshell plastic case.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

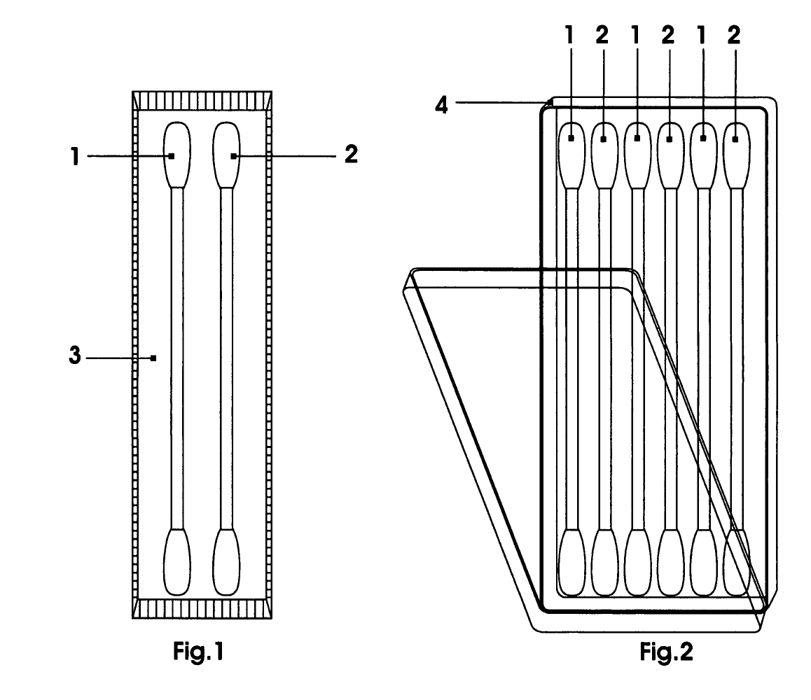

The present invention is a two step cleaning-treatment process and packaging that is portable and can be used anytime and anyplace and applied with great accuracy to desired location. As shown in FIGS. 1 and 2, the two step cleaning-treatment process and packaging comprises of a small portable packaging with one or more swab applicators 1 for cleaning and one or more swab applicators 2 for treatment.

The packaging may comprise of a foil type of seal 3, such as aluminum foil, with two applicators 1, 2, one with the cleaning solution and the other with the treatment medication as shown in FIG. 1. The packaging may also comprise of a small hardshell plastic case 4 such as that shown in FIG. 2 with multiple applicators 1 with the cleaning solution on one side and multiple applicators 2 with the treatment solution on the other side or with alternating applicator 1 with the cleaning solution and applicator 2 with the treatment solution. In another embodiment, the packaging may comprise of two small hardshell plastic cases each with multiple applicators enclosed. In one of the small hardshell plastic case are disposed multiple applicators with the cleaning solution, and in the other small hardshell plastic case are disposed multiple applicators with the treatment solution.

In the preferred embodiment, the cleaning solution is sealed within the swab applicator 1 and may be easily released into the applicator tip for application, and the treatment medication is also sealed within another swab applicator 2 and may be easily released into the applicator tip for application. The preferred swab applicator is the slender tubular container disclosed in U.S. Pat. No. 5,702,035. Other applicators such as pre-moistened pads may also be used.

The cleaning solution may be water or any other liquid or cream that has cleaning properties on the skin. The most preferred cleaning solution is a non-toxic environmentally friendly aqueous disinfectant disclosed in U.S. Pat. No. 6,197,814 B1.

The treatment medication may be any of the commercially available over the counter treatments or prescription medications. For acne, over-the-counter medication such as benzoyl peroxide, salicylic acid, sulfur, and resorcinol, or prescription medication such as adapalene, azelaic acid, benzoyl peroxide, clindamycin, erythromycin, sodium sulfacetamide, tazorotene, and tretinoin may be used. For athlete's foot, anti-fungal creams or liquids may be used as well as miconazole, ketoconazole, econazole, clotrimazole, oxiconazole, sulconazole, terconazole, terbinafine, and naftifine.

An user only has to take with him a small unit dose package that can both clean and treat the skin anytime anyplace. The user may conveniently carry as many of the small unit dose package as necessary and clean and apply the treatment medication as often as necessary. The user does not need to have access to water or a sink to perform the cleaning and treatment regiment. Furthermore, the cleaning and treatment may be performed with pinpoint accuracy without affecting the surrounding healthy skins.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

1. A two step cleaning-treatment process comprising the steps of:
cleaning a surface with a first applicator with a cleaning solution; and
treating said surface with a second applicator with a treatment medication;
wherein said first applicator with said cleaning solution and said second applicator with said treatment medication are packaged together within a single portable package.

2. A two step cleaning-treatment process as in claim 1, wherein said first applicator and said second applicator are slender tubular containers as disclosed in U.S. Pat. No. 5,702,035.

3. A two step cleaning-treatment process as in claims 1 or 2, wherein said cleaning solution is water or a non-toxic environmentally friendly aqueous disinfectant as disclosed in U.S. Pat. No. 6,197,814 B1.

4. A two step cleaning-treatment process as in claims 1 or 2, wherein said treatment medication is benzoyl peroxide, salicylic acid, sulfur, resorcinol, adapalene, azelaic acid, benzoyl peroxide, clindamycin, erythromycin, sodium sulfacetamide, tazorotene, tretinoin, anti-fungal cream or liquid, miconazole, ketoconazole, econazole, clotrimazole, oxiconazole, sulconazole, terconazole, terbinafine, or naftifine.

5. A two step cleaning-treatment process as in claims 1 or 2, wherein said single portable package is an aluminum foil.

6. A two step cleaning-treatment process as in claims 1 or 2, wherein said single portable package is a hardshell plastic case.

7. A two step cleaning-treatment packaging comprising:
a single portable packaging;
a first applicator with a cleaning solution disposed within said single portable packaging; and
a second applicator with a treatment medication disposed within said single portable packaging;
wherein said first applicator is used to clean a surface thereafter said second applicator is used to medically treat said surface.

8. A two step cleaning-treatment packaging as in claim 7, wherein said first applicator and said second applicator are slender tubular containers as disclosed in U.S. Pat. No. 5,702,035.

9. A two step cleaning-treatment process as in claims 7 or 8, wherein said cleaning solution is water or a non-toxic environmentally friendly aqueous disinfectant as disclosed in U.S. Pat. No. 6,197,814 B1.

10. A two step cleaning-treatment process as in claims 7 or 8, wherein said treatment medication is benzoyl peroxide, salicylic acid, sulfur, resorcinol, adapalene, azelaic acid, benzoyl peroxide, clindamycin, erythromycin, sodium sulfacetamide, tazorotene, tretinoin, anti-fungal cream or liquid, miconazole, ketoconazole, econazole, clotrimazole, oxiconazole, sulconazole, terconazole, terbinafine, or naftifine.

11. A two step cleaning-treatment process as in claims 7 or 8, wherein said single portable package is an aluminum foil.

12. A two step cleaning-treatment process as in claims 7 or 8, wherein said single portable package is a hardshell plastic case.
